(19) United States
(12) Patent Application Publication
(10) Pub. No.: US 2007/0215185 A1
(43) Pub. Date: Sep. 20, 2007

(54) Cleaning Apparatus, in Particular for the Wheels of a Golf Trolley

(76) Inventor: John Broadhurst, Northamptonshire (GB)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 10/593,917

(22) PCT Filed: Mar. 18, 2005
(86) PCT No.: PCT/GB05/01038

§ 371 Date: Sep. 22, 2006

(30) Foreign Application Priority Data
Mar. 25, 2004 (GB) 0406703.9
Sep. 22, 2004 (GB) 0421090.2

(51) Int. Cl. B60S 3/04; B08B 13/00

(52) U.S. Cl. 134/45; 134/123

(57) ABSTRACT

Cleaning apparatus, particularly suitable for cleaning the wheels of golf trolleys (20) comprises a support surface (3) along which the trolley is rolled from an entry end (27) to an exit end (28) and manifolds (16), (17) which spray water downwardly and outwardly towards the respective wheels. The rolling surface and inner surface of which each wheel is cleaned directly by the water jets whilst the outer surface of each wheel is cleaned by water bouncing from side walls (6), (7) of the auxiliary cleaning apparatus (30) may be provided for cleaning golf clubs.

### CROSS REFERENCE TO RELATED APPLICATIONS

This application claims the benefit of PCT Application No. PCT/GB2005/001038, filed Mar. 18, 2005, and GB Application Nos. 0406703.9, filed Mar. 25, 2004, and 0421090.2, filed Sep. 22, 2004, all of which are herein incorporated by reference.

### BACKGROUND OF THE INVENTION

1. Field of the Invention

This invention relates to cleaning apparatus, and in the preferred embodiment provides a simple and robust apparatus for cleaning dirt from the wheels of a trolley, particularly but not exclusively a golf trolley.

2. Description of the Related Art

Golf trolleys, consisting of a frame mounted on a pair of wheels and supporting a bag, are commonly used for the transporting of golf clubs around a golf course. As a result of normal usage it is common for the wheels particularly of such golf trolleys to be soiled by mud and/or grass cuttings. If the golf trolley is brought indoors (at a clubhouse or at home) or placed in a car for transport purposes, dirt from the wheels is liable to soil the surfaces upon which the trolley is placed. Further, unless the dirt is cleaned off immediately after use it is liable to dry on the wheels and detract from the appearance of the trolley.

It is known to use a conventional water hose for washing dirt from the wheels of a trolley, but such an arrangement is generally unsatisfactory. A conventional hand held hose is not, in net, very effective at removing dirt, and unless used with great care is liable to wet the bag, which is undesirable.

Various machines have also been proposed for the purpose of washing golf trolleys. Examples from the prior art include DE-A-4133667, DE-A-3923213 and DE-A-29515272 U. These prior art devices are typically characterized by a relatively complex structure including mechanically driven brushes for removing dirt from the rolling surface of wheels. Such arrangements are relatively complex to implement and not particularly effective in use. Further, because the driving mechanisms of such arrangements are prone to be contaminated with dirt removed from the wheels special care must be taken at considerable cost to ensure a long service life. Also, particularly in the case of DE-A-4133667, the exit route for the trolley re-covers the entry route for the trolley. In other words, the trolley is removed from the device by a reverse of the operation which inserts it into the device. Such arrangements are highly unsatisfactory since the cleaned wheels will be contaminated with material deposited at the entry end of the device by dirty trolleys.

Accordingly, the need exists for apparatus to provide simple, effective and automatic washing of the wheels of a golf trolley.

### SUMMARY OF THE INVENTION

Accordingly, one aspect of the present invention provides cleaning apparatus for cleaning the wheels of a trolley, the apparatus comprising: a base having a static support surface along which the trolley may be wheeled from an entry end located at one end of the apparatus to an exit end located at the other end of the apparatus; a wall structure extending upwardly from each side of the support surface; a roof extending outwardly from each wall towards the other wall; and water jets located adjacent each respective roof and spaced from and directed towards the wall associated with that respective roof for cleaning portions of a wheel located beneath that roof.

The cleaning apparatus of the preferred embodiment is configured so that the spacing between the roofs is sufficient to allow the body of a golf trolley to pass between the roofs while the wheels move along the support surface with the upper parts of the wheels located beneath the roofs. Preferably, the apparatus is open at both ends so that the trolley may be wheeled through the cleaning apparatus in a single continuous movement. As the wheels pass beneath the roofs, they will rotate by virtue of the forward movement of the trolley and as a result each part of each wheel will, in turn, be subject to cleaning by the water jets.

By providing water jets which are mounted adjacent the roof and are directed towards the associated wall, the inner surface of each wheel (that is the surface nearer the centre of the trolley) will be cleaned by the direct action of the water jets. Similarly, the rolling surface of the wheels will be cleaned by the direct action of the water jets. However, some of the water from the water jets will bypass the wheel and will impinge on the associated wall surface. The water pressure is selected so that the water will bounce from the wall surface to wash the outer side of each wheel. The advantage of this arrangement is that no water jets are directed inwardly towards the centre of the apparatus (i.e. in the direction towards the centre of the trolley as it passes through the apparatus). As a result escape of water as spray is minimized with the result that a golf bag mounted on the trolley is not significantly wetted by the cleaning operation.

Accordingly, the preferred embodiment of the present invention provides a simple and effective mechanism for removing dirt from the wheels of a trolley simply by wheeling the trolley along a defined support surface with the wheels located under the roofs.

In the preferred embodiment of the invention a skirt extends downwardly from the edge of each roof which is remote from the associated wall so that each wall together with its associated roof and the skirt associated with that roof forms a hood which is open towards the longitudinal centre-line of the apparatus.

The hoods are effective to prevent significant wetting of any part of the trolley other than the wheels.

Preferably, only one set of water jets is associated with each root, located at the juncture of the roof and the skirt.

It has been found that if the jet size and water pressure are appropriately selected the device is effective to wash the wheels of the trolley with only one set of water jets associated with each roof, thereby avoiding excessive escape of splashed water from the apparatus.

Preferably, the support surface is perforated and in the preferred embodiment is provided by a mesh support which allows ready draining of water. Water draining through the mesh support is preferably collected in a tray forming part of the cleaning apparatus, and may be recycled for further cleaning operations or discarded to a suitable drain.

Preferably, automatic means are provided for detecting the presence of a trolley and turning on the water jets. Such means may, for example, be provided by a proximity sensor or a photoelectric sensor. Accordingly, the apparatus may sit in a quiescent state with no water flowing through the jets and may be automatically started by the simple action of pulling a trolley onto the support surface. Preferably, the jets are supplied from a high pressure water source, for example a positive displacement pump.

In a particularly preferred embodiment of the invention, an auxiliary cleaning facility is provided for cleaning golf clubs. This auxiliary facility may comprise a receptacle into which the heads of clubs may be placed individually or as a group, the receptacle being furnished with water jets for removing dirt from the club heads. In a particularly preferred embodiment of the invention the receptacle is in the form of a trough into which the heads of a plurality of clubs may be placed simultaneously.

### BRIEF DESCRIPTION OF THE DRAWINGS

The invention will be better understood from the following description of a preferred embodiment thereof given by way of example only, reference being had to the accompanying drawings wherein:

FIG. 1 illustrates schematically a preferred embodiment of the present invention.

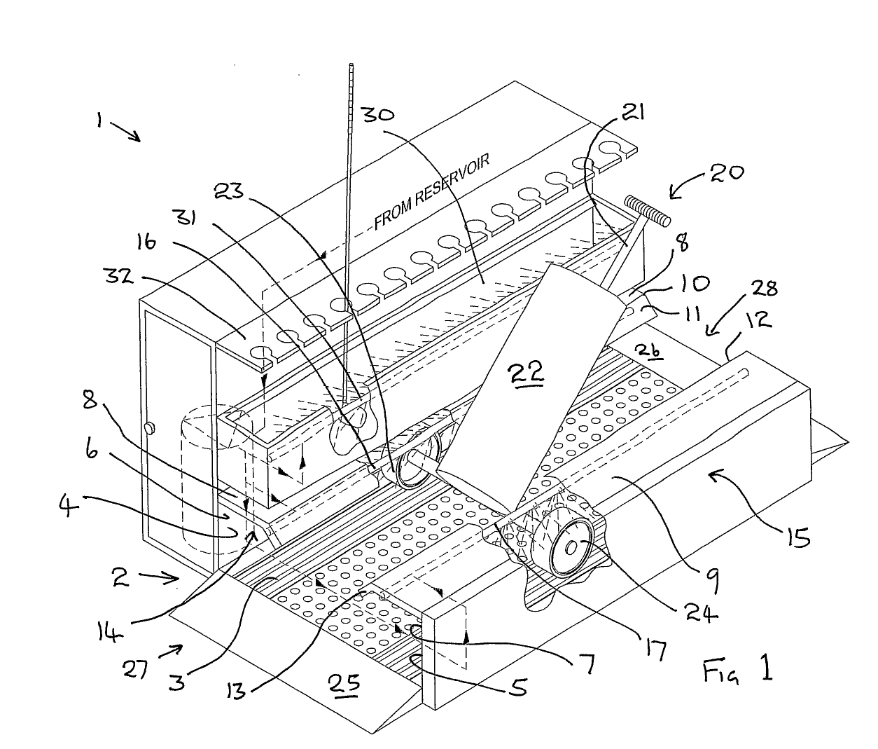

### DETAILED DESCRIPTION OF THE PREFERRED EMBODIMENTS

Referring to the drawings, the illustrated cleaning apparatus 1 comprises a base 2 having a support surface 3. The support surface 3 is formed of a suitable material, for example stainless steel bars or mesh, and the base 2 is formed to define a tray under the support surface 3. Accordingly, water and dirt falling on the support surface 3 will drain into the tray for disposal or recirculation.

At each edge of the support surface 3 a wall 4, 5 extends vertically upwardly to define a respective side surface 6, 7. At a distance h above the support surface 3, a roof 8 extends away from the wall 4 towards the wall 5 and a corresponding roof 9 extends away from the wall 5 towards the wall 4. At the edge 10 of the roof 8, which is remote from the wall 4, a skirt 11 is attached to the roof 8 and depends towards the support surface 3. Similarly, at the edge 12 of the roof 9 which is remote from the wall 5, a skirt 13 is attached to the roof 9 and depends towards the support surface 3. The wall 4, roof 8 and skirt 11 on the one hand and wall 5, roof 9 and skirt 13 on the other hand form respective hoods 14, 15. The hoods 14, 15 are each open at both ends thereof so that the wheel having a diameter of less than h can be rolled along the support surface with the upper part of the wheel located below the roof

Within each hood 14, 15 is located a manifold 16, 17 each of which is, in use, connected to a source of water under pressure. Each manifold 16, 17 includes a plurality of jets which, in use, form a plurality of sprays of water or other suitable cleaning material. Preferably, the jets are supplied from a high pressure water source 41, for example a positive displacement pump. The water may, if desired include a cleansing additive such as a detergent and may be derived directly from the mains, from a suitable source of non-potable water or by recirculation of water from the trough beneath the support surface 3. Makeup water or filtered water may be stored in a reservoir 40. Each manifold 16, 17 and its associated jets are arranged such that a spray pattern is created which extends from the manifold towards its associated wall 5, 6 and downwardly towards the outer regions of the support surface 3. The spray pattern created preferably extends through substantially 90° so that part of the spray pattern flows substantially horizontally from each manifold 16, 17 parallel to the under surface of the associated roof 8, 9 and part of the spray pattern extends substantially vertically towards the support surface 3. The arrangement under the hood 15 is the mirror image of the arrangement under the hood 14.

In use, a golf trolley 20 comprising a frame 21, a bag 22, and wheels 23, 24 is positioned to stand on the support surface 3. The wheels 23, 24 are located such that the upper part of each wheel is located inside of an associated respective hood 14, 15. The bag 22, and remaining portions of the frame 21, are located between the skirts 11, 13 or above the level of the hoods 14, 15. The ends of the hoods 14, 15 are open. Ramps 25, 26 are provided at the opposite ends of the machine to facilitate pulling the trolley in a single action through the machine from an inlet end 27 to an exit end 28. As the trolley 20 passes through the machine, water sprayed from the manifolds 16, 17 will directly wash the inner surface of each wheel (that is the surface facing the centre of the trolley) and the tread of each wheel. Water bouncing off the walls 6, 7 will wash the outer surface of each wheel (that is the surface located remote from the centre of the trolley). By the time the trolley reaches the outlet end 28 the wheels will be completely cleaned.

In a preferred embodiment of the invention automatic means are provided for switching the machine on as a trolley is placed on the support surface 3. Such means may conveniently be proximity sensors or photoelectric sensors.

It will be noted that because the trolley exits from the machine at the opposite end from that at which it entered the machine there will be no contamination of the cleaned wheels by dirt left by dirty wheels at the entry end 27 of the machine.

Referring again to the drawings the preferred embodiment of the invention incorporates means for cleaning the heads of golf clubs. Such means may comprise a trough 30 located above the hood 14. The trough 30 incorporates one or more manifolds 31 to provide an inwardly and downwardly directed spray of suitable cleaning fluid. Clubs may be stacked in the trough 30 with the handles of the clubs supported by means of a suitable bar 32 and the machine actuated to spray water onto the club heads to clean them.

As an additional feature the invention may include means for assisting in the removal of dirt from the wheels, for example static brushes or compressed air jets. Additionally, a preferred embodiment of the invention may include means for at least partially drying the wheels and other wetted areas of the trolley. Such means may include, for example, hot or cold air blasts.

1. A cleaning apparatus for cleaning the wheels of a trolley, the apparatus comprising:
a base having a static support surface along which the trolley may be wheeled from an entry end located at one end of the apparatus to an exit end located at the other end of the apparatus;
a wall structure extending upwardly from each side of the support surface;
a roof extending outwardly from each wall towards the other wall; and
a plurality of water jets located adjacent each respective roof and spaced from and directed towards the wall associated with that respective roof for cleaning portions of a wheel located beneath that roof

2. The cleaning apparatus according to claim 1 which is open at both ends so that a trolley to be cleaned may pass through the apparatus from one end to the other.

3. The cleaning apparatus according to claim 1, wherein each roof has associated therewith, at the edge of the roof remote from the wall, a downwardly depending skirt whereby each wall, the roof and skirt forming a hood.

4. The cleaning apparatus according to claim 3, wherein each hood houses one manifold, each manifold having a plurality of jets for spraying water at a wheel passing through the hood.

5. The cleaning apparatus according to claim 4, wherein each manifold is located at the juncture of a roof and its associated skirt and the spray pattern of the jets associated with each manifold covers an arc from substantially horizontal parallel to the under surface of the roof to substantially vertical directed towards the support surface.

6. The cleaning apparatus according to claim 4, wherein the manifolds are supplied from a high pressure positive displacement pump.

7. The cleaning apparatus according to claim 1, wherein support surface is a mesh surface through which water can drain.

8. The cleaning apparatus according to claim 1, further comprising a means for detecting the presence of a trolley and activating the cleaning apparatus in response to a detected trolley.

9. The cleaning apparatus according to claim 1, additionally comprising an auxiliary cleaning facility for cleaning golf clubs.

10. The cleaning apparatus according to claim 9 wherein, the auxiliary cleaning facility comprises:
a trough into which the heads of golf clubs may be placed;
and a plurality of jets for spraying water at the golf clubs in the trough.

11. The cleaning apparatus according to claim 9, further comprising means to assist removal of water from one of the trolley and clubs.

12. The cleaning apparatus according to claim 11, wherein the means to assist removal of water comprise air jets.

13. A cleaning apparatus for cleaning the wheels of a trolley, the apparatus comprising:
a base having a static support surface along which the trolley may be wheeled from an entry end located at one end of the apparatus to an exit end located at the other end of the apparatus;
a wall structure extending upwardly from each side of the support surface;
a roof extending outwardly from each wall towards the other wall;
a downwardly depending skirt disposed at the edge of each roof remote from the wall so that each roof and respective associated skirt form a hood; and
at least one manifold disposed within each hood, each manifold having a plurality of jets for spraying water at a wheel passing through the hood.

14. The cleaning apparatus according to claim 3, additionally comprising an auxiliary cleaning facility for cleaning golf clubs.

15. The cleaning apparatus according to claim 14, further comprising means to assist removal of water from one of the trolley and clubs.

16. The cleaning apparatus according to claim 15, wherein the means to assist removal of water comprise air jets.

17. A cleaning apparatus for cleaning the wheels of a trolley, the apparatus comprising:
a base having a static support surface along which the trolley may be wheeled from an entry end located at one end of the apparatus to an exit end located at the other end of the apparatus;
a wall structure extending upwardly from each side of the support surface;
a roof extending outwardly from each wall towards the other wall; and
a wheel cleaning element disposed underneath each roof for cleaning portions of a wheel located beneath that roof.

18. The cleaning apparatus according to claim 17, wherein the each wheel cleaning element comprises:
at least one manifold; and
a plurality of jets for spraying water at a wheel passing through the hood, the plurality of jets being disposed within the manifold.

19. The cleaning apparatus according to claim 18, wherein a spray pattern of the jets disposed within each manifold covers an arc from substantially horizontal parallel to the under surface of the roof to substantially vertical directed towards the support surface.

20. The cleaning apparatus according to claim 19, further comprising a means for detecting the presence of a trolley and activating the cleaning apparatus in response to a detected trolley.
